(19) United States
(12) Patent Application Publication
(10) Pub. No.: US 2020/0383762 A1
(43) Pub. Date: Dec. 10, 2020

(54) DENTAL TREATMENT ASSISTING TOOL

(71) Applicants: Pil Ho JONG, Gimhae-si (KR); Jae Hwan JEONG, Suwon-si (KR)

(72) Inventors: Pil Ho JONG, Gimhae-si (KR); Jae Hwan JEONG, Suwon-si (KR)

(21) Appl. No.: 16/476,451

(22) PCT Filed: Jan. 4, 2017
(86) PCT No.: PCT/KR2017/000078

§ 371 Date: Jul. 8, 2019

(30) Foreign Application Priority Data
Jan. 8, 2016 (KR) 10-2016-0002874

(51) Int. Cl. A61C 17/14; A61C 3/06; A61C 19/00

(52) U.S. Cl. CPC A61C 17/14; A61C 19/00; A61C 3/06

(57) ABSTRACT

The present invention provides a dental treatment assisting tool which allows various foreign materials generated when teeth are being polished or plaque is being removed during dental treatment to be easily withdrawn to the outside without having to swallow and also allows breathing through the mouth. Specifically, the dental treatment assisting tool comprises: a base plate (1) having a generally circular shape on plane, having a concave upper side so that saliva or foreign materials can be easily collected to the center thereof, and having an elliptical spatial part (12) formed on one side thereof for a tongue to be seated therein; and an air supply pipe (2) which is a soft resin pipe connected to a hole (14) bored in the center of the base plate (1). Accordingly, during the dental treatment, the entire throat may be sealed in a breathable state for a patient. The present invention has the many advantages of being capable of completely preventing the backflow of solid foreign materials to the throat by filtering the same by means of a blocking plate made of a soft material during treatment and ensuring a comfortable and pleasant treatment as nasal breathing through the nose and also oral breathing through the mouth can be freely performed.

### TECHNICAL FIELD

The present invention relates to an assisting tool used for mouth treatment in a dental clinic and, more particularly, an assisting tool for aid or guidance in order to easily discharge different foreign materials generated when polishing teeth or removing plaque during dental care to the outside without a problem of swallowing the same.

### BACKGROUND ART

Conventional dental treatment has generally adopted a mouth cleaning method using a simple suction tool composed of a rubber hose to remove (or discharge) foreign materials generated due to plaque or tooth polishing from the mouth. However, such a method as described above could not efficiently prevent a backflow phenomenon in which foreign materials generated during tooth polishing (that is, “debris”) moves to a deep part and passes through the throat, causing a problem that patients swallow a considerable amount of debris along with saliva.

Further, since a patient should breath through the nasal cavity (nose) only while closing the throat inside the tongue during dental care, serious difficulty in breathing is inevitable and causes additional suffering such that a large amount of debris is inevitably swallowed along with saliva, hence entailing more intensified difficulty in dental treatment.

In order to solve the above problems, Korean Registered Utility Model Publication No. 20-0317515 proposed a tooth protector for preventing foreign matter such as a dental prosthesis or filling, which may momentarily fall out of a tooth when attaching or detaching the prosthesis or filling, from being swallowed. The above publication has disclosed that the tooth protector has a configuration wherein: a body of the protector has a size not to pass through the throat in order to prevent debris falling from teeth during dental treatment from entering the esophagus or airway; a plurality of insertion slots is formed along the edge of the protector body by a predetermined interval; and an adjustable string is inserted into the insertion slots in a zigzag pattern so that the body may wrap the debris in a bag form by pulling the adjustable string, thereby easily and safely removing the debris.

Further, Korean Patent Laid-Open Publication No. 1998-087815 disclosed a mouth protector for dental treatment, being inserted in the mouth to protect the oral cavity, with a configuration of: a frame 2 formed in a desirable shape to fit a mouth guard 1 in the mouth when opening the mouth; and a thin protective film 4 integrally attached to the frame 2, wherein the frame 2 and the protective film 4 suppress movement of the tongue of a patient while blocking a liquid in order to prevent the liquid from passing through the throat, and the protective film 1 is inserted in the mouth so as to ensure a clear and wide view, thereby implementing safe and comfortable medical treatment.

However, the prior art has such problems that a blocking plate readily wobbles due to movement of the tongue and the patient cannot breathe through the mouth but should breathe using the nose only, hence causing discomfort in breathing. Accordingly, there was a limit in affording actual convenience and comfort to patients, which in turn caused a problem of no practical use in the industry.

### PRIOR ART DOCUMENT

### Patent Document

(Patent Document 1) KR 20-0317515 Y1 (Jun. 11, 2003)

(Patent Document 2) KR Patent 1998-087815 A (Dec. 5, 1998)

### DISCLOSURE

### Technical Problem

The present invention proposes a novel technique to overcome the aforementioned problems of the conventional art, and an object of the present invention is to provide a foreign matter backflow prevention device composed of a soft silicon material, which may be installed at a throat inlet portion to prevent the foreign matter from reversing into the throat upon receiving dental care, with a configuration of preventing different foreign materials generated during dental care from being swallowed while sufficiently breathing through the mouth.

Further, another object of the present invention is to provide a dental treatment assisting tool that occupies a space for tongue movement and fully implements inherent functions regardless of nausea, vomiting, coughing and/or tongue movement of the patient.

Meanwhile, further objects of the present invention not clarified herein may also be considered within a range that can be easily inferred from the following detailed description and effects thereof.

### Technical Solution

In order to solve the above problems, the present invention provides a foreign matter backflow prevention device with a specific configuration of: a blocking plate for backflow prevention (‘blocking plate’) composed of a silicon material to facilitate free breathing of a patient; and an air duct mounted in the center of the blocking plate in order to communicate with external air, wherein free air suction and discharge are possible through the air duct when the patient breathes, while a solid foreign material such as debris is blocked by the blocking plate but freely discharged to the outside through a suction hose.

### Advantageous Effects

According to the above configuration of the present invention, dental care is implemented by inserting a backflow prevention blocking plate into a deep position in the mouth, that is, a throat inlet portion, while opening the mouth during dental care, breathing through the mouth (“oral breathing”) as well as breathing through the nose (“nasal breathing”) may be freely performed so that a patient can receive dental treatment while taking a comfortable position. Especially, solid foreign materials during dental care such as tooth polishing, plaque removal, etc. are stuck in the blocking plate made of a soft material to fully prevent a backflow phenomenon of the solid foreign materials through the throat of the patient so that the patient can comfortably receive the dental care without fearing such foreign material backflow phenomenon, thereby achieving advantages of relieving pain while improving comfort during dental treatment.

In particular, the present invention has effects of significantly contributing to convenience of both patients and medical personnel even in dental care for children or the elderly who cannot tolerate pain during dental treatment.

### DESCRIPTION OF DRAWINGS

FIG. 1 is a perspective view illustrating an external configuration of a dental treatment assisting tool for dental clinics according to the present invention.

FIG. 2 is a cross-sectional view illustrating the dental treatment assisting tool of the present invention in a state of application.

FIG. 3 is a plan view illustrating how to apply the dental treatment assisting tool of the present invention.

FIG. 4 is a side cross-sectional view illustrating how to apply the dental treatment assisting tool of the present invention.

FIG. 5 illustrates how to apply the dental treatment assisting tool according to an embodiment of the present invention.

FIG. 6 illustrates alternative embodiments of the air duct.

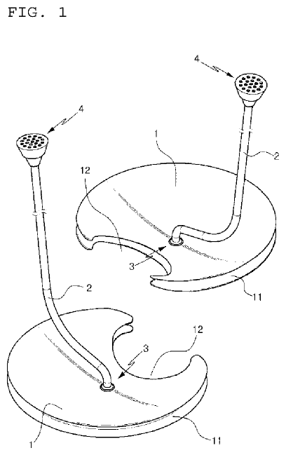

### BEST MODE

Hereinafter, with reference to the accompanying drawings, a concrete description to implement the present invention will be given below. Further, if known functions in relation to the present invention are apparent to those skilled in the art and are determined to undesirably obscure the subject matter of the present invention, a detailed description thereof will be omitted.

The present invention provides a blocking device for preventing backflow of foreign materials such as debris, which is able to block the throat while opening the mouth, in order to facilitate long term remedial practice during dental care, with an external configuration of a base plate 1 and an air supply duct 2 (hereinafter referred to as “air duct”).

The base plate 1 is made of a soft resin material such as silicon rubber, is approximately circular in a plan view and has a configuration wherein a center portion is thick but a thickness of the base plate gradually decreases toward the outer side, thereby affording a buffer function when a dental treatment assisting tool of the present invention enters the inside of the mouth.

In addition, an upper portion may be in a concave form to easily collect saliva, debris or the like to the center, and an elliptical space 12 may further be formed to insert and seat the tongue at one side, thereby ensuring tongue movement and securely fixing the base plate at a desired site regardless of such tongue movement.

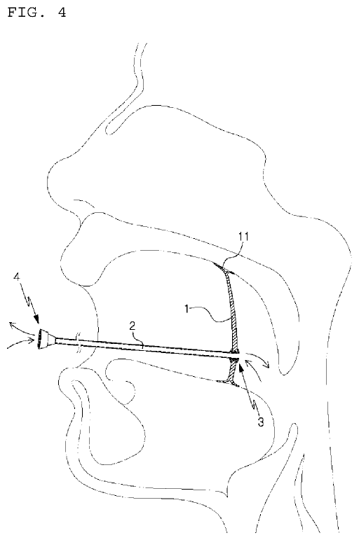

On a peripheral surface of the base plate configured as described above, a rim 11 split into two members may further be provided. As shown in FIG. 4, when the inventive device enters the oral cavity of the mouth of a patient, such configured rim may be widened toward both sides at the palate of the mouth and serve as an adsorption pad in order to increase sealability. Two rim members are effective to double shield a liquid foreign material such as saliva or blood, thereby having an advantage of superior blocking effects.

After punching a hole 14 in the center of the base plate 1, the air duct 2 may contact the hole.

The air duct is provided to allow the patient to breathe through the mouth and, if a diameter of the air duct is unnecessarily large, a treatment space may be narrowed. Therefore, the air duct is preferably formed to have a diameter of 1.5 times to 2 times an average nostril size of subjects in different age groups.

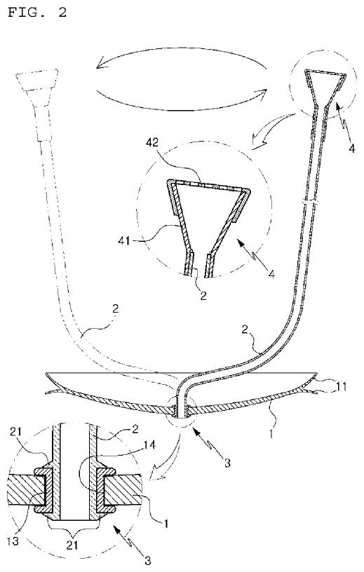

As shown in FIG. 2, the air duct contact part has a configuration of a rotary member 3 placed in the hole 14 of the base plate 1, wherein the rotary member 3 is engaged and supported on a shoulder 21 formed at an end of the air duct by fitting an eyelet 13 into the hole 14 so as to facilitate smooth and flexible rotation of the air duct 2 in a bent shape. As a result, the air duct is configured to flexibly alter a retraction direction thereof depending upon a treatment direction.

Although not shown in the figures, the air duct may also be configured like a flexible hose typically used in a water tap or faucet, whereby as large a treatment space as possible may be advantageously afforded by properly adjusting the bending and direction of the hose during medical treatment.

In this case, it is sufficient that the air duct 2 is securely connected to the base plate only with omitting a structure of the rotary member 3 instead of configuring the air duct 2 to rotate inside the eyelet 13 fitted in the hole 14 of the base plate 1.

Further, a funnel tube 4 may be connected at an outer end of the air duct 2 to smoothly input air and have a structure wherein an expander 41 of the funnel tube is covered with a sieve 42 to block foreign matter input from the outside while easily breathing through the air duct 2.

The present invention with such a configuration as described above may be used to minimize foreign material input through the throat while breathing through the mouth during dental care, and the following description explaining use thereof will be given.

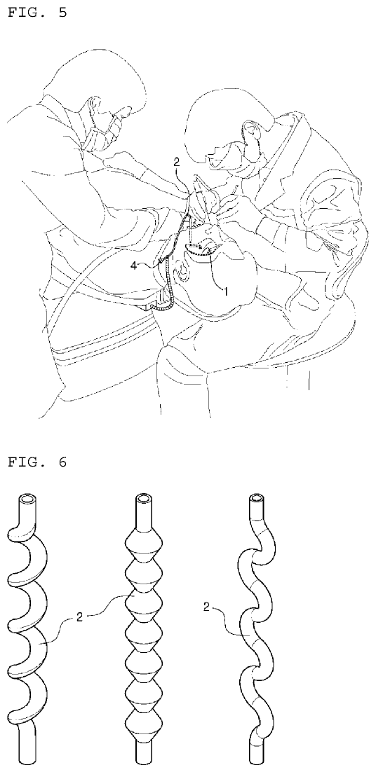

FIG. 5 illustrates how to apply the dental treatment assisting tool according to an embodiment of the present invention. When a patient opens his mouth while lying on a chair for dental care, among components of the inventive device, the air duct 2 is held and placed to seat the tongue in the space 12, followed by pushing the base plate 1 into the throat to be placed on the palate and the tongue, thereby sealing and supporting the entire throat, as shown in FIG. 4. In this condition, the inventive device may be temporarily secured.

Even when the patient feels sick and moves the tongue or vomits, the base plate 1 may move very little due to the space 12 formed below the base plate, and the rim split around the periphery of the device may facilitate rigid fixing.

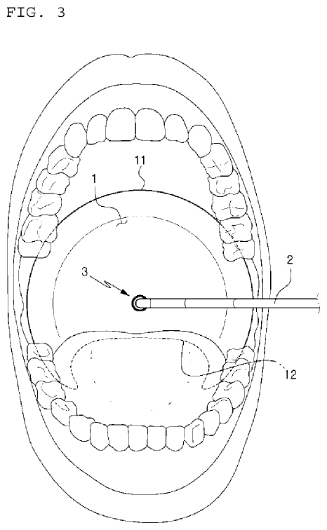

In such a fixed state, as shown in FIG. 3, the base plate 1 may have a sealing function in all directions around the throat inlet portion, whereby solid foreign materials such as tooth debris generated due to tooth polishing during dental care may be held in a concave upper portion of the base plate without backflow to the throat. Therefore, vomiting or inconvenience occurring when a suction tool is deeply inserted into the throat of a patient as in the prior art may be eliminated and, in addition, an advantage of easily taking out the same is achieved.

In this case, the patient only needs to open their mouth in a comfortable position in order to receive all treatment procedures without any conscious action to block foreign matter input to the open mouth by closing the throat and applying a pressure to the uvular portion in the open mouth state. Consequently, the patient can be treated without pain, in particular, oral breathing through the air duct 2 is easily performed along with breathing through the nasal cavity during treatment, so that even a patient having nasal congestion may breathe through the mouth and receive the medical treatment while comfortably and pleasantly breathing.

In this regard, the base plate 1 is composed of a soft silicon material and may be provided with a rim 11 around the outer peripheral surface thereof, thereby affording medical treatment to the patient without causing significant discomfort or pain in the throat area. Further, the air duct 2 has a curved surface to thus allow the rotary member 3 to easily rotate, thereby not disrupting the treatment procedure.

FIG. 6 illustrates another embodiment of the air duct 2, wherein the air duct may have different shapes such as a spiral, wave or ellipsoid form.

The above configuration is intended to eliminate a possibility that might cause pain by the base plate stuck deeply into the mouth if perhaps the air duct 2 is pressed due to carelessness of the medical personnel. In this case, even if external force is applied due to a weight of the air duct itself or carelessness during medical treatment, the external force transmitted to the base plate may be offset.

Further, a funnel tube 4 having a sieve 42 is coupled at the outer side of the air duct 2 and may basically block swallowing of the debris when a patient breathes, thereby further improving safety in use.

When the treatment is complete and the air duct 2 is taken out, the base plate 1 may be easily pulled out of the entire throat, thereby being easily withdrawn. Further, in the sight of the patient, treatment using the blocking plate may avoid bad breath of the medical personnel and eliminate a possibility of swallowing saliva, in addition, the breathing air is fed by the air duct 2 from a place away from the medical personnel to thus ensure a pleasant environment. On the other hand, in a doctor or nurse position, a foul smell coming from a deep part in the mouth of a patient with contagious disease is blocked by the base plate 1, thereby assuring comfort and safety. Accordingly, beneficial effects on the medical personnel as well as patients may be achieved.

As such, the present invention provides a device having a very simple structure configured to facilitate breathing while blocking the entire throat so that backflow of foreign matter may be basically blocked during dental treatment and a patient may have more comfortable and pleasant dental care. Therefore, the present invention is remarkably effective and useful as a safety assisting tool for dental clinics.

As such, most preferred embodiments of the present invention have been stipulated in the detailed description. However, various modifications and alterations will also be possible within a range not departing from the technical scope of the present invention. Accordingly, the protected scope of the present invention is not limited to the above embodiments but will be recognized in regard to techniques in the claims described later and technical means equal to the same.

### DESCRIPTION OF REFERENCE NUMERALS

1: Base plate 11: Rim 12: Space 13: Eyelet 14: Hole

2: Air duct 21: Shoulder

3: Rotary member

4: Funnel tube 41: Expander 42: Sieve

1. A dental treatment assisting tool for dental clinics, comprising:
a base plate (1) generally flat and circular in plan view, which has an elliptical space (12) formed at one side thereof with a concave upper side to easily collect saliva or foreign materials in the center thereof, thereby seating a tongue therein; and
a hole (14) bored in the center of the base plate (1) and an air duct (2) which is a soft resin pipe connected to the hole (14), whereby the entire throat can be sealed in a breathable state during dental care,
wherein an eyelet (13) is fitted into the hole (14) of the base plate (1) and is engaged and supported on a shoulder (21) formed at an end of the air duct (2), so that the air duct (2) is freely rotatably coupled to the base plate (1).

2. The tool according to claim 1, wherein the base plate (1) is provided with a thin split rim (11) around a periphery thereof so as to closely adsorb the base plate (1) inside the mouth.

3. The tool according to claim 1, wherein the air duct (2) is provided with a funnel tube (4) at an outer end thereof in order to smoothly input air, and the funnel tub has a sieve (42) at an expander (41) of the funnel tube.
